(19) United States
(12) Patent Application Publication
(10) Pub. No.: US 2025/0205884 A1
(43) Pub. Date: Jun. 26, 2025

(54) ROBOT CONTROL DEVICE AND ROBOT SYSTEM

(71) Applicant: FANUC CORPORATION, Yamanashi (JP)

(72) Inventors: Shigeo YOSHIDA, Yamanashi (JP); Hiromitsu TAKAHASHI, Yamanashi (JP)

(73) Assignee: FANUC CORPORATION, Yamanashi (JP)

(21) Appl. No.: 18/847,497

(22) PCT Filed: Jun. 27, 2022
(86) PCT No.: PCT/JP2022/025455

§ 371 Date: Sep. 16, 2024

(51) Int. Cl. B25J 9/16; B23K 9/12

(52) U.S. Cl. CPC B25J 9/1633; B23K 9/124

(57) ABSTRACT

A robot control device according to one embodiment of the present disclosure is capable of appropriately starting welding and controls a robot that performs welding of a welded object by using a welding torch that feeds a welding wire. The robot control device comprises: a welding command unit that commands the welding; an external force acquisition unit that acquires a value of external force acting on the robot; a robot stopping unit that stops operation of the robot if a value acquired by the external force acquisition unit is a first threshold value or greater; and a wire stopping unit that stops feeding of the welding wire if a value acquired by the external force acquisition unit is a second threshold value or greater at the beginning of the welding.

### TECHNICAL FIELD

The present invention relates to a robot control device and a robot system.

### BACKGROUND ART

Robot welding is widespread in which welding work is performed by causing a robot to hold a welding torch at a leading end thereof and moving the welding torch by the robot. In arc welding in which a welding wire serving as filler metal is used, it is necessary to feed the welding wire at an appropriate speed. Especially at the time of starting welding, there may be a case where appropriate arc discharge cannot be established, and a fed welding wire comes into contact with a welding target object. There is a risk that reaction force generated by the contact of the welding wire with the welding target object affects other control that is based on external force acting on the robot. By way of specific example, when control in which the robot is brought to an emergency stop in response to detection of abnormal external force acting on the robot is performed for safety, there is a risk that reaction force generated by contact of the welding wire with the welding target object is determined to be abnormal external force, and the robot is brought to an emergency stop by mistake. In order to prevent such an adverse effect to the control based on other external force, there is proposed a technique in which an external force detection threshold is increased larger than usual at the time of starting welding (see, for example, Patent Document 1).

### CITATION LIST

### Patent Document

Patent Document 1: PCT International Publication No. WO2021/182243

### DISCLOSURE OF THE INVENTION

### Problems to be Solved by the Invention

In the case where the external force detection threshold for safety is set high, external force below the threshold, which is temporarily increased, is allowed even if the external force is equal to or above an ordinary threshold. When such external force continues for a short time, no problem occurs. However, when the external force continuously acts during the start of welding, there is a risk that the robot and the welding torch will be adversely affected. Therefore, a technique enabling welding to appropriately start is desired.

### Means for Solving the Problems

A robot control device according to an aspect of the present disclosure is a robot control device for controlling a robot that performs welding of a welding target object using a welding torch, the welding torch feeding a welding wire, the robot control device including: a welding instruction unit configured to give an instruction to perform the welding; an external force acquisition unit configured to acquire a value of external force acting on the robot; a robot stopping unit configured to stop operation of the robot in a case where the value acquired by the external force acquisition unit is equal to or above a first threshold; and a wire stopping unit configured to stop feeding of the welding wire in a case where the value acquired by the external force acquisition unit is equal to or above a second threshold at a time of starting the welding.

### Effects of the Invention

According to the present disclosure, it is possible to start welding without affecting other control performed in accordance with external force acting on a robot.

### BRIEF DESCRIPTION OF THE DRAWING

FIG. 1 is a schematic diagram showing a configuration of a robot system according to a first embodiment of the present disclosure.

### PREFERRED MODE FOR CARRYING OUT THE INVENTION

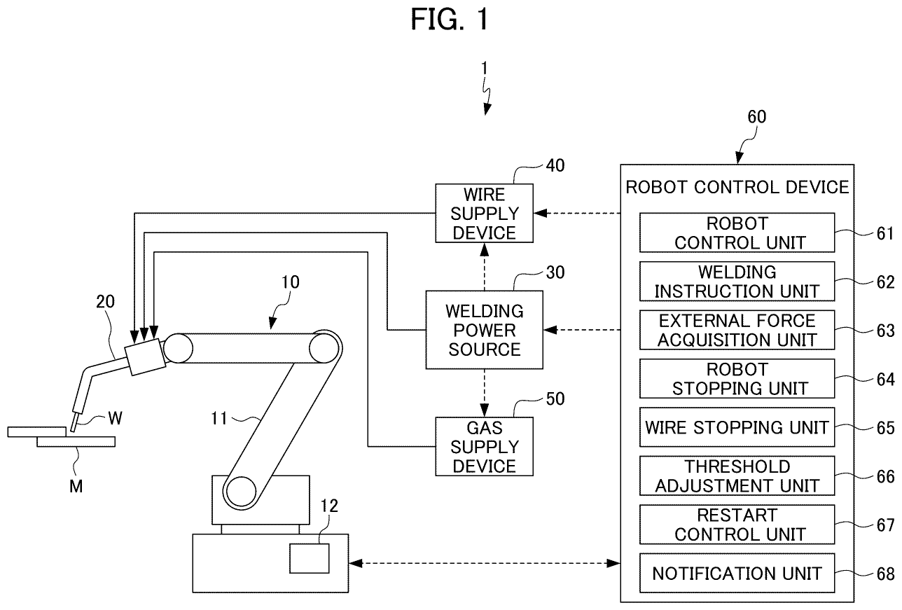

An embodiment of the present disclosure will be described below with reference to a drawing. FIG. 1 is a schematic diagram showing a configuration of a robot system 1 according to a first embodiment of the present disclosure.

The robot system 1 includes a robot 10, a welding torch 20, a welding power source 30, a wire supply device 40, a gas supply device 50, and a robot control device 60. The robot system 1 is an apparatus that performs welding of a welding target object M by moving the welding torch 20 by the robot 10. In general, the welding target object M is composed of two portions, and welding is performed to integrate the two portions with each other.

The robot 10 holds the welding torch 20 at its leading end, and the robot 10 is controlled by the robot control device 60 to position the welding torch 20, that is, cause the welding torch 20 to face a part of the welding target object M that is to be welded. As the robot 10, a vertical articulated robot having an arm 11 with a plurality of mutually rotatable links is typically adopted as shown in FIG. 1. The robot 10, however, is not limited thereto and may be, for example, a Cartesian coordinate robot, a SCARA robot, or a parallel link robot.

Further, the robot 10 includes an external force detection unit 12 that detects external force acting on the arm 11 directly or via the welding torch 20. The external force detection unit 12 can be configured, for example, to include a force sensor that detects external force acting on the arm 11. Further, the external force detection unit 12 may be configured to calculate the external force acting on the arm 11, from the torque of a motor of the robot 10. Therefore, the external force detection unit 12 may be configured to calculate the value of external force acting on the arm 11 based on a feedback value from the robot 10, as a component of the robot control device 60.

The welding torch 20 can be configured to feed a welding wire (linear filler metal) W supplied from the wire supply device 40, at the same speed, cause arc discharge to occur between itself and the welding target object M by a welding current supplied from the welding power source 30, and perform arc welding in which the material of the welding wire W is melted into the welding target object M with heat generated by the arc discharge. Further, the welding torch 20 may be configured to prevent oxidation of a welded part by injecting shielding gas supplied from the gas supply device 50. The arc welding using the welding torch 20 may include, for example, MIG welding, MAG welding, and TIG welding. Therefore, the welding torch 20 is appropriately designed according to an adopted welding method, and may be configured such that the welding wire W is used as a consumable electrode or such that the welding wire W is supplied to an area where a non-consumable electrode discharges electricity.

The welding power source 30 supplies the welding current for performing arc welding, to the welding torch 20, that is, applies voltage between the welding target object M and the welding torch 20. As the welding power source 30, a well-known power supply device for welding can be used. Further, it is preferable that the welding power source 30 be configured so that the value of the welding current or the welding voltage can be adjusted in real time according to a setting signal inputted from the robot control device 60. Further, the welding power source 30 may output signals to control the wire supply device 40 and the gas supply device 50. Although the wire supply device 40 and the gas supply device 50 can be usually controlled in conjunction with the welding current, a configuration is preferable in which at least the wire supply device 40 can be controlled also by an instruction that is independent from an instruction that the robot control device 60 provides to specify the welding current.

The wire supply device 40 supplies the welding wire W to the welding torch 20 based on an instruction from the welding power source 30 or the robot control device 60. The wire supply device 40 pulls out the welding wire W from a wire supply source (not shown) such as a wire drum and supplies the welding wire W to the welding torch 20 at a specified speed. As the wire supply device 40, a well-known device capable of changing the supply amount (the linear speed) of the welding wire W according to an external signal can be used.

The gas supply device 50 supplies shielding gas to the welding torch 20 based on an instruction from the welding power source 30 or the robot control device 60. As the shielding gas, gas mainly composed of inert gas, for example, carbon dioxide gas or argon gas is used.

The robot control device 60 is per se one embodiment of the robot control device according to the present disclosure. The robot control device 60 controls the robot 10, the welding power source 30, and the wire supply device 40, and furthermore controls the welding torch 20 and the gas supply device 50 when necessary. The robot control device 60 may control the wire supply device 40 via the welding power source 30. The robot control device 60 can be realized by one or more computer devices each of which includes a memory, a processor, an input/output interface, and the like and executes an appropriate control program.

The robot control device 60 includes a robot control unit 61, a welding instruction unit 62, an external force acquisition unit 63, a robot stopping unit 64, a wire stopping unit 65, a threshold adjustment unit 66, a restart control unit 67, and a notification unit 68. These components indicate classification of functions of the robot control device 60 and do not have to be clearly distinguishable from each other in terms of physical configuration and program configuration.

The robot control unit 61 causes the robot 10 to operate in accordance with a welding program that specifies operations required for the welding torch 20, such as a welding position and a welding speed, and specifies operating conditions for the welding power source 30, the wire supply device 40, and the gas supply device 50.

The welding instruction unit 62 instructs the welding power source 30 and the wire supply device 40 to perform welding according to the welding program. In other words, the welding instruction unit 62 instructs the welding power source 30 to perform supply of the welding current and the like so as to synchronize with operation of the robot 10, and also instructs the wire supply device 40 to start and stop feeding of the welding wire W and specifies the speed thereof directly or via the welding power source 30. The welding power source 30 or the wire supply device 40 is configured to give priority to the specified value from the welding instruction unit 62 even when the welding power source 30 has a speed for the welding wire W according to another parameter.

The external force acquisition unit 63 acquires a value of external force acting on the robot 10, from the external force detection unit 12. The external force acquisition unit 63 may have a conversion function, such as A/D conversion, of converting the value of the external force acting on the robot 10 to information that can be processed in the robot control device 60, for example, A/D conversion.

If the value acquired by the external force acquisition unit 63 is equal to or above a first threshold, the robot stopping unit 64 stops operation of the robot 10. In other words, if external force acting on the robot 10 is equal to or above the first threshold, the robot stopping unit 64 brings the robot 10 to an emergency stop for safety, assuming that the robot 10 may have come into contact with an unexpected person or object.

If the value acquired by the external force acquisition unit 63 is equal to or above a second threshold at the time of starting welding, the wire stopping unit 65 stops feeding of the welding wire. In other words, if external force acting on the robot 10 increases at the time of starting welding, there is a high probability that the start of welding (establishment of appropriate arc discharge) has failed, and that reaction force due to the welding wire W coming into contact with the welding target object M without being melted is detected. Accordingly, the wire stopping unit 65 prevents further increase in the reaction force by stopping feeding of the welding wire W once. Note that “the time of starting welding” when the wire stopping unit 65 performs the above control means a period from when the welding instruction unit 62 gives an instruction to start welding until it is determined that stable welding has started. By way of example, a period until a predetermined waiting time has elapsed after an instruction to start welding or perform retry to be described later, or a period until establishment of stable arc discharge is detected by some method after an instruction to start welding can be regarded as the time of starting welding. Usually, movement of the welding torch 20 is started after that.

Since the second threshold that the wire stopping unit 65 uses is set independently from the first threshold used by the robot stopping unit 64, the wire stopping unit 65 can appropriately determine start of welding irrespective of the operating state of the robot stopping unit 64. It is preferable that the second threshold used by the wire stopping unit 65 be smaller than the first threshold used by the robot stopping unit 64. Thereby, even if external force acting on the robot 10 due to failure of the start of welding, it is possible to try to start welding again without stopping the robot 10.

The threshold adjustment unit 66 adjusts the value of the second threshold that the wire stopping unit 65 uses, according to any one or more of welding conditions and the state of the robot 10. Since the magnitude of reaction force detected when the welding wire W comes into contact with the welding target object M changes depending on the welding conditions and the state of the robot 10, the feature in which the threshold adjustment unit 66 adjusts the value of the second threshold according to these conditions allows the wire stopping unit 65 to more appropriately detect failure of the start of welding.

More specifically, it is preferable that the threshold adjustment unit 66 adjust the value of the second threshold according to any one or more of the feeding speed, material, and diameter of the welding wire W, and the posture of the robot 10. Deformation of the welding wire W causes force to be dispersed between the welding target object M and the welding torch 20 or causes delay in communication. Therefore, the feature in which the threshold adjustment unit 66 adjusts the value of the second threshold according to conditions of the welding wire W allows the wire stopping unit 65 to appropriately detect failure of the start of welding. Further, the posture of the robot 10 changes the distance from the position at which the external force detection unit 12 detects force to the tip of the welding torch 20, and thereby changes the detection sensitivity of the external force detection unit 12. Therefore, the feature in which the threshold adjustment unit 66 increases or decreases the second threshold to compensate for the change in the detection sensitivity allows the wire stopping unit 65 to appropriately detect failure of the start of welding.

The restart control unit 67 causes a welding resumption procedure for resuming welding to be executed. The welding resumption procedure that the restart control unit 67 causes to be executed can include a process of stopping supply of the welding current to the welding torch 20, a process of pulling back the welding wire W, and a process of resuming supply of the welding current and feeding of the welding wire W. In other words, the restart control unit 67 can be configured to instruct the welding power source 30 or the wire supply device 40 to resume pulling back and feeding of the welding wire W, in response to the wire stopping unit 65 stopping feeding of the welding wire W. In other words, the restart control unit 67 may execute an arc retry sequence for returning the position relationship to the initial state by pulling back the welding wire W to separate the welding wire W from the welding target object M, and retrying a welding start procedure for trying establishment of arc discharge from the beginning. Thus, by trying to start welding again when start of welding fails, it is possible to appropriately start welding without a user performing an operation again.

The restart control unit 67 may cause the robot 10 to operate to move the welding torch 20 along the welding target object M, in response to the wire stopping unit 65 stopping feeding of the welding wire W. Specifically, the welding resumption procedure may include the process of stopping supply of the welding current to the welding torch 20, the process of pulling back the welding wire W, and the process of performing resumption of supply of the welding current and feeding of the welding wire W and the operation of the robot 10 by which the welding torch 20 is moved back and forth along the welding target object M. In other words, the restart control unit 67 may be configured to execute a scratch start sequence for inducing arc discharge by scraping the surface of the welding target object M with the welding wire W to remove insulation coating and the like from the surface of the welding wire W or the welding target object M or by forming minute gaps by way of, for example, slight unevenness on the surfaces of the welding wire W and the welding target object M, the elasticity of the welding wire W, and the like. Thus, by trying to start welding while causing the welding torch 20 to move along the welding target object M when start of welding fails, it is also possible to appropriately start welding without the user performing an operation again.

The restart control unit 67 may, when the wire stopping unit 65 stops feeding of the welding wire W, cause the robot 10 to operate to move the welding torch 20 back and forth along the welding target object M without rewinding the welding wire W. In other words, the welding resumption procedure may further include the operation of the robot 10 causing the welding torch 20 to move back and forth along the welding target object M after supply of the welding current to the welding torch 20 is stopped and before the welding wire W is pulled back. Thus, the insulation coating and the like is removed from the surface of the welding wire W or the welding target object M by causing the robot 10 to move back and forth while the welding wire W is in contact with the welding target object M, and thereafter, welding is started again in a state in which the welding torch 20 is accurately rearranged at a position where welding is to be started. This makes it possible to accelerate start of welding and suppress deviation of the position where welding is to be started. The welding resumption procedure after the welding wire W in contact with the welding target object M is moved back and forth may be implemented with the welding torch 20 being moved as described above or may be implemented without moving the welding torch 20.

When the value acquired by the external force acquisition unit 63 becomes equal to or above a third threshold during the welding resumption procedure, the restart control unit 67 may cause the welding resumption procedure to be executed from the beginning after stopping feeding of the welding wire W. By detecting, by means of the third threshold, contact of the welding wire W with the welding target object M at the time of starting welding, it is possible to more appropriately determine whether establishment of arc discharge has succeeded or failed. The third threshold may be equal to or above the second threshold. However, since the possibility of the welding wire W being in contact with the welding target object M due to a factor other than success/failure of arc discharge, for example, the shape of the welding target object M or the like, is low at the time of starting welding in comparison with the case of continuing welding, failure of the start of welding can be detected more quickly by setting the third threshold to a value smaller than the second threshold. The restart control unit 67 may enable detection of contact of the welding wire W with the welding target object M using the second threshold during the welding resumption procedure without setting the third threshold.

The restart control unit 67 can be configured to, in the case of not being able to resume welding, that is, in the case of detecting contact of the welding wire W with the welding target object M during the welding resumption procedure, repeat the welding resumption procedure a number of times set in advance or a number of times specified according to a condition set in advance. The restart control unit 67 may be configured to implement a plurality of welding presumption procedures in predetermined order.

When the wire stopping unit 65 stops feeding of the welding wire, the notification unit 68 provides a notification to that effect. The content of the notification may be changed according to a result of retry of start of welding by the restart control unit 67. Inclusion of the notification unit 68 makes it possible to prompt the user to take a measure such as start of welding by a manual operation, optimization of parameters for the welding start procedure, and the like.

In the robot system 1 including the robot control device 60 described above, the wire stopping unit 65 detects contact of the welding wire W with the welding target object M, which is detected as external force acting on the robot 10, by way of comparison with the second threshold and stops feeding of the welding wire to prevent further increase in the external force. This can make it less likely for the failure of the start of welding have adverse effects on other control by the robot stopping unit 64, etc., which are performed based on external force acting on the robot 10.

Although an embodiment of the present disclosure has been described above, the present invention is not limited to the above embodiment. The effects described in the above embodiment are merely exemplified as preferred effects obtained by the present invention, and effects of the present invention are not limited to those described in the above embodiment.

In the robot control device according to the present invention, the first threshold is not limited to a threshold that is used for determination on emergency stop of the robot by the robot stopping unit and may be, for example, a threshold that is used for determining whether to correct a parameter for robot posture control or the like.

In the robot control device according to the present invention, the threshold adjustment unit is optional. Further, in the robot control device according to the present invention, the restart control unit and the notification unit are also optional, and, instead of these, a component performing other processing that can be adopted as measures against failure of the start of welding may be provided.

According to the present disclosure, it is also possible to provide a robot control unit including the wire stopping unit and the restart control unit without including the robot stopping unit. A robot control device according to another aspect of the present disclosure is a robot control device for controlling a robot that performs welding of a welding target object using a welding torch, the welding torch feeding a welding wire, the robot control device including: a welding instruction unit configured to give an instruction to perform the welding; an external force acquisition unit configured to acquire a value of external force acting on the robot; a wire stopping unit configured to stop feeding of the welding wire in a case where the value acquired by the external force acquisition unit is equal to or above a predetermined threshold (the second threshold in the embodiment described above); and a restart control unit configured to execute a welding resumption procedure for resuming the welding when the wire stopping unit stops feeding of the welding wire. The welding resumption procedure includes: a process of stopping supply of a welding current to the welding torch; a process of moving the welding torch back and forth along the welding target object; a process of pulling back the welding wire; and a process of resuming supply of the welding current and feeding of the welding wire.

Thus, by causing the welding torch to move back and forth along a welding target object without supplying the welding current in a state in which the welding wire seems to come into contact with the welding target object, insulation coating and the like on the surface of the welding wire and the welding target object can be removed. Thereafter, supply of the welding current and supply of the welding wire are restarted after pulling back the welding wire, thereby increasing the possibility that arc discharge can be established. The process of stopping supply of the welding current to the welding torch, the process of moving the welding torch back and forth along a welding target object, the process of pulling back the welding wire, and the process of resuming supply of the welding current and feeding of the welding wire in the welding resumption procedure may be executed immediately after the wire stopping unit stops feeding of the welding wire or may be executed if, when resumption of welding in a procedure not including the above processes is tried, it is determined that the welding wire has come into contact with the welding target object again, for example, when the value acquired by the external force acquisition unit is equal to or above the third threshold in the embodiment described above.

### EXPLANATION OF REFERENCE NUMERALS

1 robot system
10 robot
11 arm
12 external force detection unit
20 welding torch
30 welding power source
40 wire supply device
50 gas supply device
60 robot control device
61 robot control unit
62 welding instruction unit
63 external force acquisition unit
64 robot stopping unit
65 wire stopping unit
66 threshold adjustment unit
67 restart control unit
68 notification unit
M welding target object
W welding wire

1. A robot control device for controlling a robot that performs welding of a welding target object using a welding torch, the welding torch feeding a welding wire, the robot control device comprising:
a welding instruction unit configured to give an instruction to perform the welding;
an external force acquisition unit configured to acquire a value of external force acting on the robot;
a robot stopping unit configured to stop operation of the robot in a case where the value acquired by the external force acquisition unit is equal to or above a first threshold; and
a wire stopping unit configured to stop feeding of the welding wire in a case where the value acquired by the external force acquisition unit is equal to or above a second threshold at a time of starting the welding.

2. The robot control device according to claim 1, wherein the second threshold is smaller than the first threshold.

3. The robot control device according to claim 1, further comprising:
a threshold adjustment unit configured to adjust a value of the second threshold according to any one or more of conditions for the welding and a state of the robot.

4. The robot control device according to claim 3, wherein the threshold adjustment unit adjusts the value of the second threshold according to any one or more of a feeding speed, a material, and a diameter of the welding wire, and a posture of the robot.

5. The robot control device according to claim 1, further comprising:
a restart control unit configured to execute a welding resumption procedure for resuming the welding when the wire stopping unit stops feeding of the welding wire.

6. The robot control device according to claim 5, wherein the welding resumption procedure includes stopping of supply of a welding current to the welding torch, pulling back of the welding wire, and resumption of supply of the welding current and feeding of the welding wire.

7. The robot control device according to claim 5, wherein the welding resumption procedure includes stopping of supply of a welding current to the welding torch, pulling back of the welding wire, resumption of supply of the welding current and feeding of the welding wire, and operation of the robot to move the welding torch back and forth along the welding target object.

8. The robot control device according to claim 7, wherein, in a case where the value acquired by the external force acquisition unit becomes equal to or above a third threshold during the welding resumption procedure, the restart control unit executes the welding resumption procedure from a beginning after stopping feeding of the welding wire.

9. The robot control device according to claim 6, wherein the welding resumption procedure further includes operation of the robot to move the welding torch back and forth along the welding target object after stopping of supply of the welding current to the welding torch and before pulling back of the welding wire.

10. The robot control device according to claim 1, further comprising:
a notification unit configured to provide a notification when the wire stopping unit stops feeding of the welding wire.

11. A robot system comprising:
the robot control device according to claim 1; and
a robot that is controlled by the robot control device and positions the welding torch.

12. The robot system according to claim 11, further comprising:
the welding torch held by the robot;
a wire supply device configured to supply the welding wire to the welding torch; and
a welding power source configured to supply a welding current to the welding torch.
